(19) United States
(12) Patent Application Publication
(10) Pub. No.: US 2004/0088925 A1
(43) Pub. Date: May 13, 2004

(54) Door seal structure of motor vehicle

(76) Inventor: Masahiro Nozaki, Aichi-ken (JP)

Correspondence Address: POSZ & BETHARDS, PLC, 11250 ROGER BACON DRIVE, SUITE 10, RESTON, VA, 20190, US

(21) Appl. No.: 10/673,276

(22) Filed: Sep. 30, 2003

(30) Foreign Application Priority Data
Oct. 4, 2002 (JP) 2002-292029

(51) Int. Cl. E06B 7/16

(52) U.S. Cl. 49/498.1; 49/490.1; 49/489.1

(57) ABSTRACT

A door seal structure for sealing between a door opening portion of a vehicle body and a door frame of a vehicle door. The door seal structure has a protrusion formed in the door frame and protruding inwardly of a glass run holding part for holding a glass run, and a cover member for covering the protrusion and concealing it from a vehicle compartment when the vehicle door is closed. The protrusion has a longitudinally extending depression near a protruding wall of the protrusion, and an inner end edge of the cover member is seated in the longitudinally extending depression. When the vehicle door is closed, the protrusion of the door frame is not seen from the vehicle compartment, and the inner end edge of the cover member does not contact a tubular seal portion of an opening weather strip attached along the door opening portion to prevent wear of the tubular seal portion. Accordingly, the appearance and durability around the door frame are improved.

### CROSS-REFERENCE TO RELATED APPLICATION

This application is related to and claims priority from Japanese patent application No. 2002-292029, incorporated herein by reference.

### BACKGROUND OF THE INVENTION

1. Field of the Invention

The present invention relates to a door seal structure between a door opening portion of a vehicle body and a door frame of a vehicle door.

2. Description of Related Art

FIG. 1 illustrates a side view of a motor vehicle. When a vehicle door 10 of the motor vehicle is closed, a door frame 12 contacts a facing door opening portion 14 of a vehicle body. Reference numeral 16 denotes a door glass of the motor vehicle.

In order to provide a seal between the door frame and the door opening portion, conventionally, a protrusion is provided inside the door frame, and a seal portion of an opening weather strip attached to the door opening portion of the vehicle body contacts and presses the protrusion of the door frame (Publication of Japanese Utility model application No. Hei 7-31442, on pages 1 to 2, and in FIG. 1, for example).

FIG. 2 illustrates one example of such a conventional door seal structure, which is taken along the line A-A of FIG. 1. As shown, a glass run holding part 18 is provided inside an outer panel 20 of the door frame 12. The glass run holding part 18 has a generally U-shaped cross-section, and a glass run 22 is held in the glass run holding part 18. An outer seal lip 24 and an inner seal lip 26 of the glass run 22 contact a periphery of the door glass 16 on both surfaces thereof, thereby sealing the periphery of the door glass 16. An end edge of an inner panel 28 of the door frame 12 is welded to an inside wall 30 of the glass run holding part 18 to define a flange 32. The inner panel 28 includes a protrusion 34 that protrudes inwardly from the flange 32.

A trim 36 having a generally U-shaped cross-section is mounted on the flange 32. An outer side wall of the trim 36 abuts an inner side wall of the glass run 22. An inner side wall of the trim 36 has a lip 38 for covering one part of the protrusion 34.

In the door opening portion, an opening weather strip 40 is attached to a flange 42 which is formed by welding end edges of an outer panel 44 and an inner panel 46 of the vehicle body. The opening weather strip 40 includes a trim portion 48 mounted on the flange 42, and a tubular seal portion 50 expanding from an outer surface of the trim portion 48. When the vehicle door 10 is closed, the protrusion 34 of the door frame 12 contacts and presses the tubular seal portion 50 of the opening weather strip 40 to seal between the door opening portion of the vehicle body and the door frame 12. At this time, an inside wall of the protrusion 34 is exposed in the part between the lip 38 of the trim 36 and the tubular seal portion 50 of the opening weather strip 40, and seen from a vehicle compartment.

Generally, a vehicle door such as a press door is coated with the color identical to that of a vehicle body. Where the coating color is white or yellow, which contrasts with black of rubber, etc. for composing the trim 36 and the door opening weather strip 40, there occur color differences around the door frame 12, thereby degrading the appearance around the door frame 12, which is visible from the vehicle compartment.

A tip end of the lip 38 of the trim 36 is pressed against the inside wall of the protrusion 34 of the door frame 12, which faces the vehicle compartment. Where the lip 38 has such a length as to cover the inside wall of the protrusion 34 entirely, the lip 38 and the tubular seal portion 50 rub together when the door is closed or when the vehicle body vibrates with the door closed, and consequently, the tubular seal portion 50 which is generally composed of a sponge rubber is undesirably worn out (Publication of Japanese unexamined patent application No. Hei 10-230740, for example). In order to prevent this defect, conventionally, the lip 38 has been made short, but this results in the part of the inside wall between the tip end of the lip 38 and the tubular seal portion 50 being exposed to the vehicle compartment.

In order to prevent the exposure of the inside wall of the protrusion 34 15 to the vehicle compartment, as shown in FIG. 3, the inside wall of the protrusion 34 may be covered with a tubular cover lip 52 which is formed by extending a trim 54 towards the opening weather strip 40. However, with this arrangement, a gap between facing surfaces of the tubular cover lip 52 and the tubular seal portion 50 must be decreased, and consequently, they may contact each other due to variations in the attachment position thereof.

### SUMMARY OF THE INVENTION

Accordingly, it is an object of the present invention to provide a door seal structure having a cover member in a door frame of a vehicle door for covering an inside wall of a protrusion of the door frame such that an end edge of the cover member does not contact a tubular seal portion of an opening weather strip attached to a vehicle body when the vehicle door is closed, thereby improving the appearance of the door frame, which is seen from a vehicle compartment.

In accordance with a first aspect of the present invention, an opening weather strip is provided in a door opening portion of a vehicle body. The opening weather strip includes a tubular seal portion which projects outwardly of the door opening portion. A glass run for guiding a door glass that is raised or lowered is held in a glass run holding part provided along an inner peripheral surface of a door frame of a vehicle door. The door frame has a protrusion which protrudes inwardly of the glass run holding part, and includes a protruding wall which is adapted to contact and press the tubular seal portion of the opening weather strip when the vehicle door is closed, and an inside wall which is adapted to face a vehicle compartment when the vehicle door is closed. The inside wall of the protrusion has a depression which is formed near the protruding wall so as to extend in a longitudinal direction of the protrusion, and a cover member is provided for covering the inside wall of the protrusion of the door frame. One end edge of the cover member is connected to the glass run and the other end edge of the cover member is seated in the longitudinally extending depression.

With the door seal structure of the first aspect, since the inside wall of the protrusion of the door frame is covered with the cover member, whereby the appearance around the door frame, which is seen from the vehicle compartment, is improved, and since the end edge of the cover member is seated in the longitudinally extending depression, the end edge of the cover member does not contact the tubular seal portion of the opening weather strip, whereby the tubular seal portion is prevented from being worn out.

In accordance with a second aspect of the present invention, an opening weather strip is provided in the door opening portion of a vehicle body. The opening weather strip includes a tubular seal portion which projects outwardly of the door opening portion. A glass run for guiding a door glass that is raised or lowered is held in a glass run holding part provided along an inner peripheral surface of a door frame of a vehicle door. The door frame has a protrusion which protrudes inwardly of the glass run holding part. An inner end edge of the protrusion is joined to an inside wall of the glass run holding part to define a flange. The protrusion includes a protruding wall which is adapted to contact and press the tubular seal portion of the opening weather strip when the vehicle door is closed, and an inside wall which is adapted to face a vehicle compartment when the vehicle door is closed. The inside wall of the protrusion has a depression which is formed near the protruding wall so as to extend in a longitudinal direction of the protrusion, and a cover member is provided for covering the inside wall of the protrusion of the door frame. One end edge of the cover member covers the flange and is connected to the glass run and the other end edge of the cover member is seated in the longitudinally extending depression.

With the door seal structure of the second aspect, since one end edge of the cover member covers the flange and is connected to an inner side wall of the glass run, the flange is concealed from the vehicle compartment to improve the appearance therearound. In addition, similarly to the first aspect, the inside wall of the protrusion of the door frame is covered with the cover member to improve the appearance around the door frame, which is seen from the vehicle compartment, and since the end edge of the cover member is seated in the longitudinally extending depression, the end edge of the cover member does not contact the tubular seal portion of the opening weather strip, whereby the tubular seal portion is prevented from being worn out.

In accordance with a third aspect of the present invention, an opening weather strip is provided in a door opening portion of a vehicle body. The opening weather strip includes a tubular seal portion which projects outwardly of the door opening portion. A glass run for guiding a door glass that is raised or lowered is held in a glass run holding part provided along an inner peripheral surface of a door frame of a vehicle door. A door weather strip for abutting and sealing the door opening portion when the vehicle door is closed is held in an outer peripheral surface of the door frame. The door frame has a protrusion which protrudes inwardly of the glass run holding part, and includes a protruding wall which is adapted to contact and press the tubular seal portion of the opening weather strip when the vehicle door is closed, and an inside wall which is adapted to face a vehicle compartment when the vehicle door is closed. The inside wall of the protrusion has a depression which is formed near the protruding wall so as to extend in a longitudinal direction of the protrusion. A cover member is provided for covering the inside wall of the protrusion of the door frame. One end edge of the cover member is connected to the glass run and the other end edge of the cover member is seated in the longitudinally extending depression.

With the door seal structure of the third aspect, since the door weather strip for abutting and sealing the door opening portion is held in an outer peripheral surface of the door frame, the outer peripheral surface of the door frame is sealed with the door weather strip while the inner peripheral surface of the door frame is sealed with the glass run. In addition, similarly to the first aspect, the inside wall of the protrusion of the door frame is covered with the cover member to improve the appearance around the door frame, which is seen from the vehicle compartment, and since the end edge of the cover member is seated in the longitudinally extending depression, the end edge of the cover member does not contact the tubular seal portion of the opening weather strip, whereby the tubular seal portion is prevented from being worn out.

In a preferred embodiment, the cover member includes a trim part which is integrally formed with one part of the inner side wall of the glass run, and a cover lip which is formed integrally with the trim part and extends inwardly from the trim part. With this arrangement, the cover member and the glass run can be manufactured at the same time, thereby reducing the manufacturing time, and the cover member and the glass run can be attached at the same time, thereby reducing the assembling time of the motor vehicle. In addition, the glass run, the trim part, and the cover lip are continuous in appearance, thereby effecting a unity in appearance of these members, which is preferable in ensuring aesthetic appearance of the motor vehicle.

In another preferred embodiment, the trim part of the cover member is mounted on the flange provided in the door frame, and an outer side wall of the trim part abuts and is connected to the glass run.

With this arrangement, the cover member is securely held by the flange of the door frame. In addition, since the outer side wall of the trim part abuts and is connected to the glass run, the glass run is securely held by the glass run holding part by virtue of the cover member.

In still another preferred embodiment, the cover member is composed of a door frame garnish which is formed separately from the glass run, and one end edge of the door frame garnish abuts and is connected to the glass run, and the other end edge of the door frame garnish is seated in the longitudinally extending depression provided in the inside wall of the protrusion near the protruding wall thereof. With this arrangement, the material for the door frame garnish can be selected freely. Where synthetic resins are used, the door frame garnish can be colored with any color so as to be preferable in designing the motor vehicle. In addition, since the door frame garnish and the glass run are formed separately from each other, the configuration of the door frame garnish becomes simple, thereby facilitating the manufacturing thereof.

In a further preferred embodiment, one end edge of the door frame garnish has a flange mounting part for mounting on the flange formed in the door frame. With this arrangement, since the door frame garnish is mounted on the flange with the flange mounting part, the door frame garnish can be mounted on the flange securely.

In a still further preferred embodiment, the longitudinally extending depression is provided in the protrusion of the door frame near each of the protruding wall thereof and the inner side wall of the glass run, one end edge of the door frame garnish is seated in the longitudinally extending depression provided near the inner side wall of the glass run, abuts the inner side wall of the glass run and is connected thereto while the other end edge of the door frame garnish is seated in the longitudinally extending depression provided near the protruding wall, and the door frame garnish is attached to the protrusion by a double-sided adhesive tape. With this arrangement, since the door frame garnish is attached by the double-sided adhesive tape, the door frame garnish can be readily attached to the protrusion of the door frame. In addition, since both end edges of the door frame garnish are seated in the longitudinally extending depressions provided in the protrusion near the protruding wall and the inner side wall of the glass run, they can be prevented from contacting both the opening weather strip and the glass run.

Other objects, features, and characteristics of the present invention will become apparent upon consideration of the following description and the appended claims with reference to the accompanying drawings, all of which form a part of this specification.

### BRIEF DESCRIPTION OF THE DRAWINGS

FIG. 1 is a side view of a motor vehicle;

FIG. 2 is a cross-sectional view of a conventional door seal structure, which is taken along the line A-A of FIG. 1;

FIG. 3 is a cross-sectional view of another conventional door seal structure, which is taken along the line A-A of FIG. 1;

FIG. 4 is a cross-sectional view of a first embodiment of a door seal structure, which is taken along the line A-A of FIG. 1;

FIG. 5 is a cross-sectional view of a second embodiment of a door seal structure in accordance with the present invention, which is taken along the line A-A of FIG. 1;

FIG. 6 is a cross-sectional view of a third embodiment of a door seal structure in accordance with the present invention, which is taken along the line A-A of FIG. 1; and

FIG. 7 is a cross-sectional view of a fourth embodiment of a door seal structure in accordance with the present invention, which is taken along the line A-A of FIG. 1.

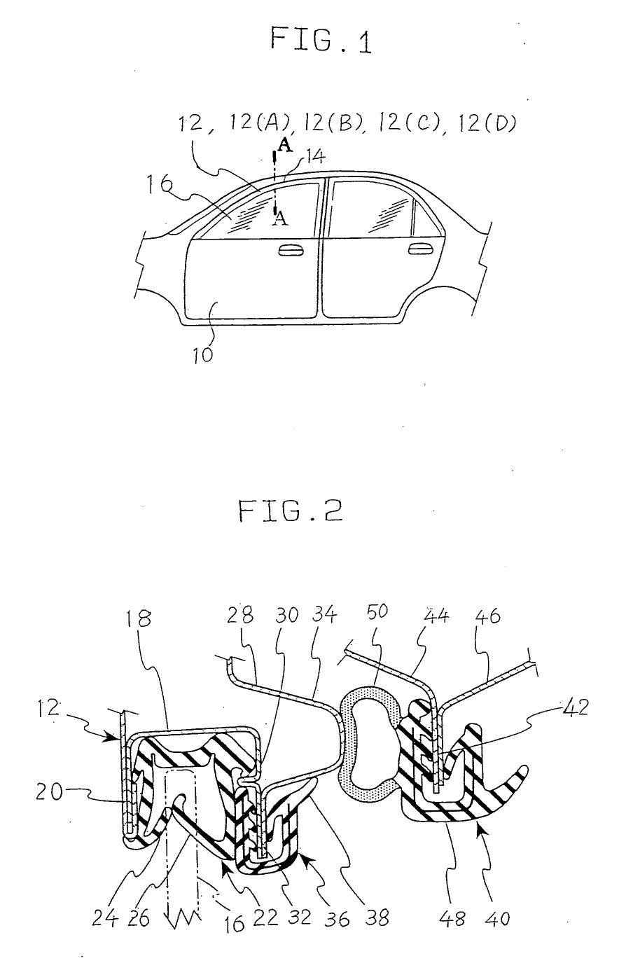

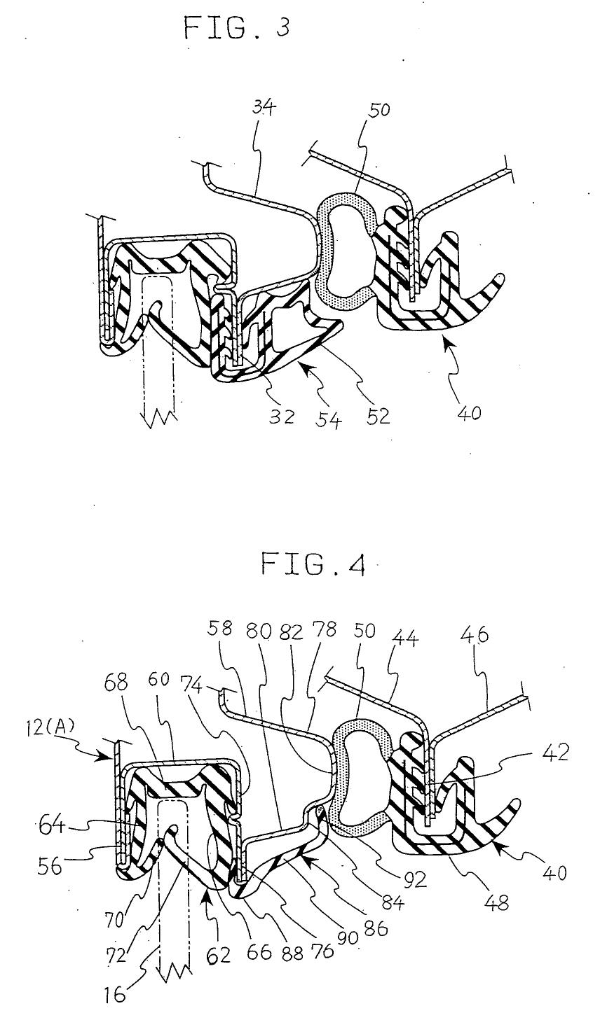

### DETAILED DESCRIPTION OF THE PREFERRED EMBODIMENTS

Hereinafter, several embodiments in accordance with the present invention will be explained with reference to FIG. 4 to FIG. 7. FIG. 4 illustrates a first embodiment of a door seal structure in accordance with the present invention. As shown, a door frame 12(A) includes an outer panel 56 and an inner panel 58. A glass run holding part 60 having a generally U-shaped cross-section is provided inside the outer panel 56, and a glass run 62 is held in the glass run holding part 60. The glass run 62 has a generally U-shaped cross-section, and includes an outer side wall 64, an inner side wall 66 and a bottom wall 68. An outer seal lip 70 projects from an open end of the outer side wall 64 towards the bottom wall 68 of the glass run 62, and an inner seal lip 72 projects from an open end of the inner side wall 66 towards the bottom wall 68 of the glass run 62. When a door glass 16 is elevated, the outer seal lip 70 and the inner seal lip 72 contact a periphery of the door glass 16 on both surfaces thereof, thereby sealing the periphery of the door glass 16.

The glass run holding part 60 may define a channel having a U-shaped cross-section, as shown in FIG. 4. Otherwise, the glass run holding part may not have a bottom for abutting the bottom wall 68 of the glass run 62.

In this case, ends of the outer panel 56 and the inner panel 58 respectively hold the outer side wall 64 and the inner side wall 66 of the glass run 62.

An end part of the inner panel 58 is welded to an inside wall 74 of the glass run holding part 60 to define a flange 76. The inner panel 58 includes a protrusion 78 that protrudes inwardly of the flange 76. The protrusion 78 has a generally U-shaped cross-section of which open ends are spread apart slightly. The protrusion 78 includes an inside wall 80 which faces a vehicle compartment, and a protruding wall 82 which has a generally flat configuration. When the vehicle door 10 is closed, the protruding wall 82 of the protrusion 78 contacts and presses a tubular seal portion 50 of an opening weather strip 40 which will be explained later.

A depression 84 is provided in the inside wall 80 near the protruding wall 82 so as to extend in a longitudinal direction of the protrusion 78.

A door frame garnish 86 is mounted on the flange 76 so as to cover the inside wall 80 of the protrusion 78. The door frame garnish 86 has a strip-shaped configuration and extends along the door frame 12(A). The door frame garnish 86 includes a mounting part 88 which is provided in an outside end edge thereof for mounting on a projecting end of the flange 76, and a main part 90 which extends from the mounting part 88 for covering the inside wall 80 of the protrusion 78. An inner end edge 92 of the door frame garnish 86 is seated in the depression 84 of the protrusion 78.

The door frame garnish 86 thus arranged covers the inside wall 80 of the protrusion 78 so that the door frame 12(A) is not seen from the vehicle compartment.

The door frame garnish 86 is provided separately from the glass run 62. Accordingly, the material for the door frame garnish 86 can be selected freely. Synthetic resins, for example, may be used as the material therefor. In addition, the manufacturing process can be made simple to facilitate the manufacturing of the door frame garnish 86. The door frame garnish 86 may be manufactured by injection molding or extrusion molding, for example. Where the door frame garnish 86 is composed of synthetic resins, the color of the door frame garnish 86 can be selected freely so as to be suited to the design of the motor vehicle.

In the door opening portion of a vehicle body, the opening weather strip 40 is attached to a flange 42 which is provided by welding end edges of an outer panel 44 and an inner panel 46 of a vehicle body. The opening weather strip 40 includes a trim portion 48 having a generally U-shaped cross-section and a tubular seal portion 50 which expands from an outer surface of the trim portion 48. The trim portion 48 is mounted on the flange 42 of the vehicle body to hold the opening weather strip 40. When the vehicle door 10 is closed, the protruding wall 82 of the protrusion 78 of the door frame 12(A) contacts and presses the tubular seal portion 50 of the opening weather strip 40, thereby sealing the door opening portion of the vehicle body and the door frame 12(A).

Since the inner end edge 92 is seated in the depression 84 of the protrusion 78 of the door frame 12(A), the inner end edge 92 of the door frame garnish 86 does not contact the tubular seal portion 50 of the opening weather strip 40 upon closing of the vehicle door 10.

Accordingly, the tubular seal portion 50 of the opening weather strip 40 is prevented from being rubbed with the inner end edge 92 of the door frame garnish 84 due to shocks occurring when the vehicle door is closed, or vibrations occurring when the vehicle is running, whereby the tubular seal portion 50 of the opening weather strip 40 is prevented from being worn out.

Even where the tubular seal portion 50 of the opening weather strip 40 contacts the door frame garnish 86, the tubular seal portion 50 contacts not an inner end edge of the door frame garnish 86 but a curved part which is apart from the inner end edge of the door frame garnish 86. Consequently, the wear of the tubular seal portion 50 is much restrained.

In addition, since the door frame garnish 86 covers only the inside wall 80 of the protrusion 78, the door frame garnish 86 can be readily assembled, the weight of the door frame garnish 86 can be made light, and the manufacturing costs thereof can be reduced, as compared with other door frame garnishes which cover the protrusion entirely.

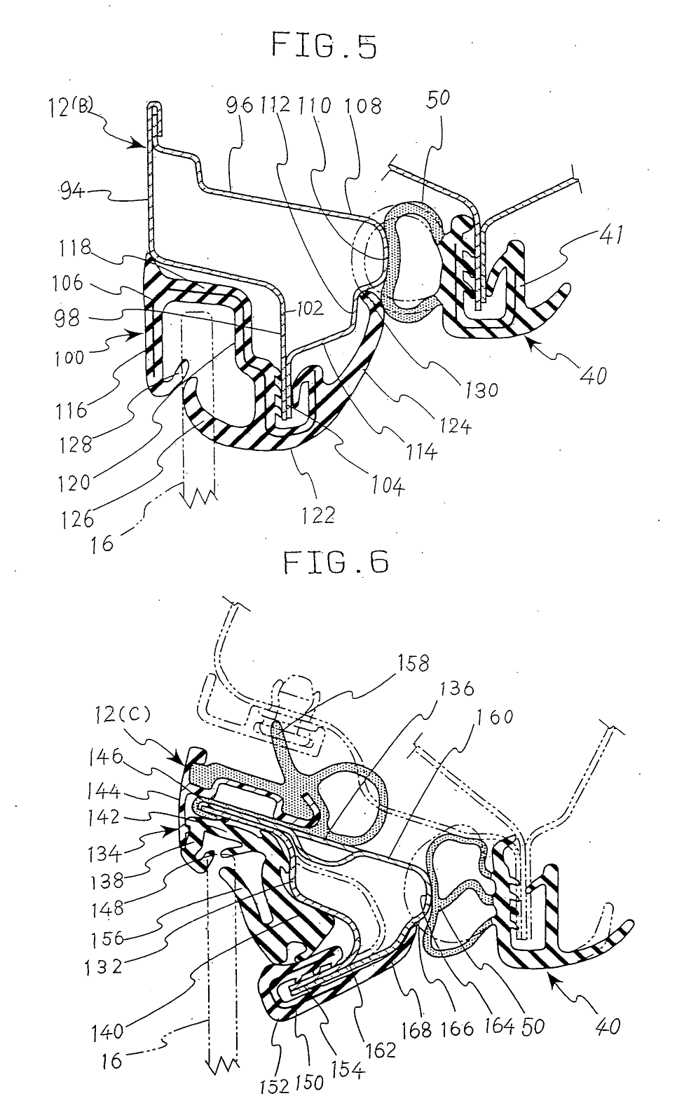

FIG. 5 illustrates a second embodiment of a door seal structure in accordance with the present invention. As shown, a door frame 12(B) includes an outer panel 94 and an inner panel 96. An inner periphery of the outer panel 94 is bent to define a depressed glass run holding part 98 for holding a glass run 100. The glass run holding part 98 includes a bottom wall and an inner side wall 102. An end part of the inner panel 96 of the door frame 12 (B) is welded to the inner side wall 102 of the glass run holding part 98 to define a flange 104.

The glass run holding part 98 does not have an outer side wall, and has a generally L-shaped cross-section. As described later, the glass run 100 may be held with a metal insert 106 embedded in the glass run 100.

The inner panel 96 includes a protrusion 108 that protrudes inwardly of the flange 104. The protrusion 108 has a generally U-shaped cross-section of which an open end is spread apart slightly. The protrusion 108 includes a protruding wall 110 having a generally flat configuration. When the vehicle door 10 is closed, the protruding wall 110 of the protrusion 108 contacts and presses a tubular seal portion 50 of an opening weather strip 40.

A depression 112 is provided in an inside wall 114 of the protrusion 108 near the protruding wall 110 so as to extend in a longitudinal direction of the protrusion 108.

The glass run 100 includes a door glass receiving part having a generally U-shaped cross-section, which is defined by an outer side wall 116, a bottom wall 118, and an inner side wall 120, a trim part 122 for mounting on the flange 104, and a cover lip 124 for covering the inside wall 114 of the protrusion 108 of the door frame 12(B).

The trim part 122 mounting on the flange 104 has a generally U-shaped cross-section, and is formed along an end edge of the inner side wall 120 of the glass run 100 integrally therewith. The inner side wall 120 of the glass run 100 serves as an outer side wall of the trim 122.

Since the inner side wall 120, an inner seal lip 126, the trim part 122 and the cover lip 124 are formed integrally with each other, there is continuity and unity in the appearance of these parts so as to be preferable in designing thereof.

The metal insert 106 is embedded in the outer side wall 116, the bottom wall 118, the inner side wall 120 and the trim part 122 to retain the shape of the glass run 100.

By mounting the trim part 122 on the flange 104, the glass run 100 is secured to the door frame 12(B). The outer side wall 116 becomes flush with an outside surface of the door frame 12(B). Though the glass run holding part 98 does not have an outer side wall, the metal insert 106 serves to retain the shape of the glass run 100, and enables the glass run 100 to guide the door glass 16.

An outer seal lip 128 projects inwardly from the outer side wall 116 of the glass run 100, and the inner seal lip 126 projects inwardly from the inner side wall 120. When the door glass 16 is elevated, a periphery of the door glass 16 is held with the outer seal lip 128 and the inner seal lip 126 with good sealing properties. The metal insert 106 is embedded in the trim part 122, too. Accordingly, the metal insert 106 enables the trim part 122 to strongly hold the flange 104, and consequently, the door glass 16 can be surely held by the glass run 100.

The cover lip 124 extends from the inner side wall of the trim part 122 for covering the inside wall 114 of the protrusion 108 of the door frame 12(B). An inner end edge 130 of the cover lip 124 is seated in the longitudinally extending depression 112 of the protrusion 108 of the door frame 12(B).

The cover lip 124 thus arranged serves to conceal the inside wall 114 of the protrusion 108 so that the door frame 12(B) is not seen from a vehicle compartment. In addition, the tubular seal portion 50 of the opening weather strip 40 does not contact the inner end edge 130 of the cover lip 124 when shocks occur upon the closing of the vehicle door, or vibrations occur during the running of the vehicle. Consequently, the tubular seal portion 50 is prevented from being rubbed with the inner end edge 130 of the cover lip 124, whereby the tubular seal portion 50 is prevented from being worn out or damaged.

Even where the tubular seal portion 50 of the opening weather strip 40 contacts the cover lip 124 of the glass run 100, the tubular seal portion 50 contacts not the inner end edge 130 of the cover lip 124 but a curved part which is apart from the inner end edge 130 of the cover lip 124. Consequently, the wear of the tubular seal portion 50 is much restrained.

The glass run 100 is formed by extrusion. The outer side wall 116, the inner side wall 120, the bottom wall 118, the trim part 122 and the cover lip 124 are integrally formed by extrusion while inserting the metal insert 106 therein. After extrusion, where the glass run 100 is formed of rubber, vulcanization is performed by a normal vulcanizing method using a high frequency vulcanizing bath or air-oven vulcanizing bath. After vulcanization, the glass run 100 is cut to have a predetermined length, and, if necessary, is joined to another part to obtain a desired product.

The glass run 100 may be composed of rubbers, thermoplastic elastomers, soft synthetic resins or the like.

The trim part 122 and the cover lip 124 may be composed of the material different from that of the outer side wall 116, the inner side wall 120 and the bottom wall 118. In this case, a duplex extrusion method can be used. In addition, a thin coloring film may be formed on surfaces of the trim part 122 and the cover lip 124 by extrusion for decorative purposes.

The remainder of the structure of the second embodiment is identical to that of the first embodiment, and accordingly explanations thereof will be omitted.

FIG. 6 illustrates a third embodiment of a door seal structure in accordance with the present invention. As shown, a door frame 12(C) includes a glass run holding part 132 for holding a glass run 134, and an inner panel 136 for defining an inside panel section. The glass run 134 has an outer side wall 138, an inner side wall 140 and a bottom wall 142. The glass run holding part 132 has a generally W-shaped cross-section, and holds the bottom wall 142 and the inner side wall 140 of the glass run 134. The outer side wall 138 of the glass run 134 is held by a door moulding 144 which defines an outside surface of the door frame 12(C), which is attached to a later-described flange 146 provided in the inner panel 136. An outer seal lip 148 projects from an open end of the outer side wall 138 of the glass run 134 towards the bottom wall 142.

The inner side wall 140 of the glass run 134 extends downwardly along the glass run holding part 132 having a generally W-shaped cross-section, and abuts a trim part 146 of a door frame garnish 152 which is mounted on a later-described flange 154. An inner seal lip 156 projects from the inner side all 140 of the glass run 134 toward the bottom wall 142 thereof. When the door glass 16 is elevated, a periphery of the door glass 16 is held with the outer seal lip 148 and the inner seal lip 156 from both surfaces thereof with good sealing properties.

End edges of the glass run holding part 132 are joined to end edges of the inner panel 136, respectively, to form flanges 146 and 154. The door moulding 144 is mounted on the flange 146, whereby the glass run 134 and a door weather strip 158 are held by the door moulding 144.

The inner panel 136 includes a protrusion 160 that protrudes inwardly of the flanges 146 and 154. The protrusion 160 includes an inside wall 162 facing a vehicle compartment, and a protruding wall 164 having a generally flat configuration. When the vehicle door 10 is closed, the protruding wall 164 of the protrusion 160 contacts and presses a tubular seal portion 50 of an opening weather strip 40.

A longitudinally extending depression 166 is provided in the inside wall 162 of the protrusion 160 near the protruding wall 164 thereof.

The door frame garnish 152 is mounted on the flange 154 so as to cover the inside wall 162 of the protrusion 160. The door frame garnish 152 has a strip-shaped configuration and extends along the door frame 12(C). The trim part 150 of the door frame garnish 152 has a generally U-shaped cross-section, and a cover lip 168 projects from the trim part 150 so as to cover the inside wall 162 of the protrusion 160. An inner end edge of the cover lip 168 is seated in the depression 166 of the protrusion 160.

The door frame garnish 152 thus arranged covers the inside wall 162 of the protrusion 160 of the door frame 12(C) so that the door frame 12(C) is not seen from the vehicle compartment. In addition, the door frame garnish 152 is attached to the flange 154 of the door frame 12(C) securely in the trim part 150 thereof.

The door frame garnish 152 is provided separately from the glass run 134. Accordingly, the material for the door frame garnish 152 can be selected freely. Synthetic resins, for example, may be used as the material therefor. In addition, the manufacturing process can be made simple to facilitate the manufacturing of the door frame garnish 152. The door frame garnish 152 may be manufactured by injection molding or extrusion molding, for example. Where the door frame garnish 152 is composed of synthetic resins, the color of the door frame garnish 86 can be selected freely so as to be suited to the designing of the motor vehicle.

In accordance with the door seal structure of the present embodiment, since the inner end edge of the door frame garnish 152 is seated in the depression 166 of the protrusion 160 of the door frame 12(C), the inner end edge of the door frame garnish 152 does not contact the tubular seal portion 50 of the opening weather strip 40, similarly to the structure of the first embodiment.

The remainder of the structure of the third embodiment is identical to that of the first embodiment, and accordingly explanations thereof will be omitted.

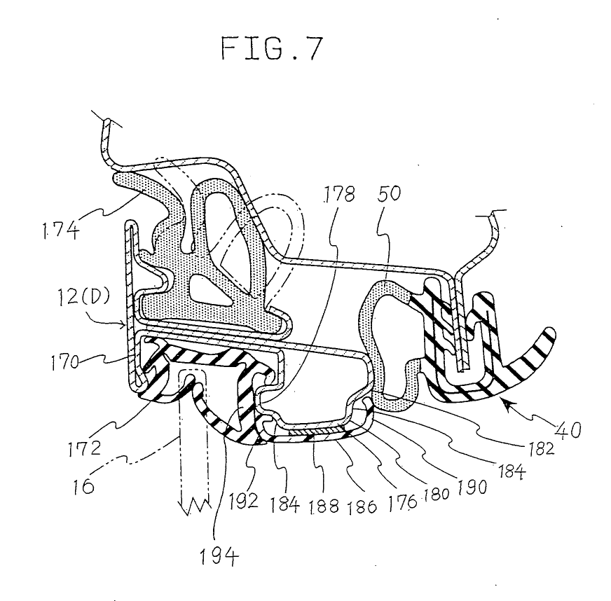

FIG. 7 illustrates a fourth embodiment of a door seal structure in accordance with the present invention. As shown, a door frame 12(D) is formed by bending a metal plate with roll-forming to define a glass run holding part 170 for holding a glass run 172 along an inner peripheral surface of the door frame 12(D), and a sash part for attaching a door weather strip 174 along an outer peripheral surface of the door frame 12(D).

A protrusion 176 protrudes inwardly of the glass run holding part 170 integrally with an inner side wall 178 of the glass run holding part 170.

The glass run 172 held by the glass run holding part 170 seals a periphery of the door glass 16 from both sides thereof, similarly to the door seal structure of the first embodiment.

The protrusion 176 includes an inside wall 180 which faces a vehicle compartment and a protruding wall 182 which has a generally flat configuration. When the vehicle door 10 is closed, the protruding wall 182 of the protrusion 176 contacts and presses a tubular seal portion 50 of an opening weather strip 40.

Longitudinally extending depressions 184 are provided along both end edges of the inside wall 180 of the protrusion 176 near the protruding wall 182 and near the inner side wall 178 of the glass run holding part 170, respectively.

A door frame garnish 186 is secured to the inside wall 180 of the protrusion 176 by a double-sided adhesive tape 188. Upon attachment, the double-sided adhesive tape 188 is bonded to a rear surface of the door frame garnish 186, and then the double-sided adhesive tape 188 bonded to the door frame garnish 186 is bonded to the inside wall 180 of the protrusion 176.

End edges 190 and 192 of the door frame garnish 186 are respectively bent into a generally L-shaped cross-section, and, upon attachment, are respectively seated in the depressions 184 provided near the protruding wall 182 and near the inside wall 178 of the glass run holding part 170.

The end edges 190 and 192 of the door frame garnish 186 do not contact the tubular seal portion 50 of the opening weather strip 40 and an inner side wall 194 of the glass run 172, consequently, the tubular seal portion 50 and the inner side wall 194 are prevented from being worn out or damaged by the end edges 190 and 192. In addition, the inside wall 180 of the protrusion 176 of the door frame 12(D) is covered with the door frame garnish 186 in the area ranging from one depression 184 to the other depression 184, whereby the protrusion 176 of the door frame 12(D) can be concealed from the vehicle compartment to improve the appearance around the door frame 12(D).

Furthermore, the attachment of the door frame garnish 186 is performed by the double-sided adhesive tape 188, thereby facilitating the attaching work of the door frame garnish 186 to the door frame 12(D).

The remainder of the structure of the second embodiment is identical to that of the first embodiment, and accordingly explanations thereof will be omitted.

In accordance with the present invention, the protrusion of the door frame is covered with a cover member, and consequently, is concealed from a vehicle compartment to improve the appearance around the door frame which is seen from passengers in the vehicle compartment. In addition, an end edge of the cover member is prevented from contacting a tubular seal portion of an opening weather strip attached along a door opening portion of a vehicle body, thereby preventing the tubular seal portion from being worn out to improve the durability and appearance around the door frame.

While the invention has been described in connection with what are considered to be the preferred embodiments, it is to be understood that the invention is not limited to the disclosed embodiments, but, on the contrary, is intended to cover various modifications and equivalent arrangements included within the spirit and scope of the appended claims.

What is claimed is:

1. A door seal structure for sealing between a door opening portion of a vehicle body and a door frame of a vehicle door, comprising:
an opening weather strip provided in the door opening portion, said opening weather strip including a tubular seal portion which projects outwardly of the door opening portion;
a glass run for guiding a door glass that is raised or lowered, said glass run being held in a glass run holding part provided along an inner peripheral surface of the door frame;
the door frame having a protrusion which protrudes inwardly of said glass run holding part, said protrusion including a protruding wall and an inside wall, said protruding wall being adapted to contact and press said tubular seal portion of said opening weather strip and said inside wall being adapted to face a vehicle compartment when the vehicle door is closed, said inside wall of said protrusion having a depression which is formed near said protruding wall so as to extend in a longitudinal direction of said protrusion; and
a cover member provided for covering said inside wall of said protrusion of the door frame, one end edge of said cover member being connected to said glass run and the other end edge of said cover member being seated in said depression.

2. A door seal structure for sealing between a door opening portion of a vehicle body and a door frame of a vehicle door, comprising:
an opening weather strip provided in the door opening portion, said opening weather strip including a tubular seal portion which projects outwardly of the door opening portion;
a glass run for guiding a door glass that is raised or lowered, said glass run being held in a glass run holding part provided along an inner peripheral surface of the door frame;
the door frame having a protrusion which protrudes inwardly of said glass run holding part, an inner peripheral end of said protrusion being joined to an inner side wall of said glass run holding part to define a flange, said protrusion including a protruding wall and an inside wall, said protruding wall being adapted to contact and press said tubular seal portion of said opening weather strip and said inside wall being adapted to face a vehicle compartment when the vehicle door is closed, said inside wall of said protrusion having a depression which is formed near said protruding wall so as to extend in a longitudinal direction of said protrusion; and
a cover member provided for covering said inside wall of said protrusion of the door frame, one end edge of said cover member covering said flange and being connected to said glass run and the other end edge of said cover member being seated in said depression.

3. A door seal structure for sealing between a door opening portion of a vehicle body and a door frame of a vehicle door, comprising:
an opening weather strip provided in the door opening portion, said opening weather strip including a tubular seal portion which projects outwardly of the door opening portion;
a glass run for guiding a door glass that is raised or lowered, said glass run being held in a glass run holding part provided along an inner peripheral surface of the door frame;
a door weather strip for abutting and sealing the door opening portion when the vehicle door is closed, said door weather strip being held in an outer peripheral surface of the door frame;
the door frame having a protrusion which protrudes inwardly of said glass run holding part, said protrusion including a protruding wall and an inside wall, said protruding wall being adapted to contact and press said tubular seal portion of said opening weather strip and said inside wall being adapted to face a vehicle compartment when the vehicle door is closed, said inside wall of said protrusion having a depression which is formed near said protruding wall so as to extend in a longitudinal direction of said protrusion; and
a cover member provided for covering said inside wall of said protrusion of the door frame, one end edge of said cover member being connected to said glass run and the other end edge of said cover member being seated in said depression.

4. A door seal structure as claimed in claim 1, wherein said cover member includes a trim part which is integrally formed with one part of said inner side wall of said glass run, and a cover lip which extends inwardly from said trim part integrally with said trim part, said trim part of said cover member is connected to said glass run, and an end edge of said cover lip is seated in said depression.

5. A door seal structure as claimed in claim 2, wherein said cover member includes a trim part which is integrally formed with one part of an inner side wall of said glass run, and a cover lip which extends inwardly from said trim part integrally with said trim part, said trim part of said cover member is connected to said glass run, and an end edge of said cover lip is seated in said depression.

6. A door seal structure as claimed in claim 3, wherein said cover member includes a trim part which is integrally formed with one part of an inner side wall of said glass run, and a cover lip which extends inwardly from said trim part integrally with said trim part, said trim part of said cover member is connected to said inner side wall of said glass run, and an end edge of said cover lip is accommodated in said depression.

7. A door seal structure as claimed in claim 5, wherein said trim part is mounted on said flange, and an outer side wall of said trim part abuts and is connected to said inner side wall of said glass run.

8. A door seal structure as claimed in claim 1, wherein said cover member is composed of a door frame garnish which is formed separately from said glass run, and one end edge of said door frame garnish abuts and is connected to an inner side wall of said glass run, and the other end edge of said door frame garnish is seated in said depression.

9. A door seal structure as claimed in claim 2, wherein said cover member is composed of a door frame garnish which is formed separately from said glass run, and one end edge of said door frame garnish abuts and is connected to an inner side wall of said glass run, and the other end edge of said door frame garnish is seated in said depression.

10. A door seal structure as claimed in claim 3, wherein said cover member is composed of a door frame garnish which is formed separately from said glass run, and one end edge of said door frame garnish abuts and is connected to an inner side wall of said glass run, and the other end edge of said door frame garnish is seated in said depression.

11. A door seal structure as claimed in claim 9, wherein said one end edge of said door frame garnish has a flange mounting part for mounting on said flange.

12. A door seal structure as claimed in claim 10, wherein an inner peripheral end of said protrusion is joined to an inner side wall of said glass run holding part to define a flange, and said one end edge of said door frame garnish has a flange mounting part for mounting on said flange.

13. A door seal structure as claimed in claim 8, wherein said protrusion has a first depression near said inner side wall of said glass run and a second depression near said protruding wall, said one end edge of said door frame garnish is seated in said first depression, and abuts and is connected to said inner side wall of said glass run, said the other end edge of said door frame garnish is seated in said second depression, and said door frame garnish is secured to said protrusion by a double-sided adhesive tape.

14. A door seal structure as claimed in claim 10, wherein said protrusion has a first depression near said inner side wall of said glass run and a second depression near said protruding wall, said one end edge of said door frame garnish is seated in said first depression, and abuts and is connected to said inner side wall of said glass run, said the other end edge of said door frame garnish is seated in said second depression, and said door frame garnish is secured to said protrusion by a double-sided adhesive tape.
